(19) United States
(12) Patent Application Publication
(10) Pub. No.: US 2008/0199834 A1
(43) Pub. Date: Aug. 21, 2008

(54) RICH AND CONCURRENT PC EXPERIENCES ON COMPUTING DEVICES

(75) Inventors: Martin Taillefer, Redmond, WA (US); Bruno Silva, Clyde Hill, WA (US); Kenneth Dwight Krossa, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/675,489

(22) Filed: Feb. 15, 2007

(51) Int. Cl. G09B 19/00

(52) U.S. Cl. 434/118

(57) ABSTRACT

According to the present disclosure, users can have PC experiences on game consoles. For example, a game console can become a computing device dedicated to a server PC. PC capabilities, applications, programs, and even desktops can be remoted from the server PC to the game console, cached on the game console, and displayed on the game console display. Moreover, any devices native to either the server PC or the game console can be easily shared between the server PC and the console. Alternatively, a game console can be a concurrent computing device with a server PC, where only minimal content is stored on the gaming console, and minimal applications are remoted from the server PC to the game console. In either the dedicated or remoted case, various common features may be used, such as notifications sent from the server PC to the game console.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright©2006, 2007 Microsoft Corp.

1. Field of Technology

The presently disclosed subject matter relates to the field of computing and/or consumer electronics, and more particularly, to fields such as game consoles and personal computers (PCs), although these are merely exemplary and non-limiting fields.

2. Background

New game consoles are moving to an always connected networked environment. They typically have very powerful hardware, and serve a multitude of entertainment needs. A large part of these consoles are set up in households in common shared areas where this entertainment can be consumed. Such common areas may include family rooms and locations next to TVs, audio/video receivers, and music and movie playback equipment. Personal computers (PCs), on the other hand, are more often located where “work” is done—typically on a desk in a den or a study, away from the family entertainment area. Nevertheless, the usage scenarios of game consoles and PC's are constantly overlapping, and these prototypical placements become inconvenient and limiting.

Moreover, there are many settings where PC functionality can become desirable in a game console setting—not only because PC experiences are fundamentally different, but because the PC's performance at different tasks may be much improved compared to a game console. Additionally, state information and user data may only be present on a single PC, and this information may need to be accessed by users via remote devices (e.g. consumer electronic or game console devices). Thus, to overcome prototypical location disparities between PCs and game consoles, and to provide for a richer overlapping of PC and game console experience, it would be advantageous to provide mechanisms that allow users to have PC experiences on game consoles without having to move to different locations and/or different machines.

### SUMMARY

According to various aspects described herein, users can have PC experiences on game consoles without having to move to different locations and/or different machines. In one aspect of the presently disclosed subject matter, a game console can become a computing device associated with a server PC. Thus, PC applications, programs, and even desktops can be remoted from the server PC to the game console, cached on the game console, and displayed (e.g. overlayed) on the game console display. Moreover, any devices native to either the server PC or the game console can be shared between the server PC and the game console.

In another aspect of the presently disclosed subject matter, a game console can be a concurrent computing device with a server PC. In this scenario, only minimal content is stored on the game console, and minimal applications are remoted from the server PC to the game console. For example, remoted content can be displayed so that users can quickly switch between native game console content and the remoted content that is executing on the server PC. In either the dedicated or remoted aspects, various common features may be used, such as notifications sent from the server PC to the game console.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are illustrated. However, the disclosure is not limited to the specific aspects shown. The following figures are included:

FIG. 1 provides a general architecture of a personal computer (PC) along with a game console, and it shows how these devices may be connected to provide a rich and concurrent PC experience to users of game consoles;

FIG. 2 illustrates that the overall PC and game system may be implemented in a variety of ways, including but not limited to (1) a dedicated system, where the game console is dedicated to the PC, and (2) a concurrent system, where the PC and the game console interact as concurrent subsystems;

FIG. 3 illustrates an aspect of the present disclosure that has client software running on the game console, where this software facilitates a PC-like experience on the game console;

FIG. 4 illustrates another aspect of the present disclosure, wherein a game console has a game console guide with a Remote Desktop Protocol (RDP) client;

FIG. 5 illustrates that the server PC and game console system can use separate communication channels for different activities;

FIG. 6 illustrates a first exemplary method flow chart of various aspects discussed in FIGS. 1-5;

FIG. 7 illustrates a second exemplary method flow chart of various aspects discussed in FIGS. 1-5;

FIG. 8 illustrates an exemplary game console;

FIG. 9 illustrates an exemplary PC; and

FIG. 10 illustrates an exemplary networking environment for the game console and the PC.

### DETAILED DESCRIPTION

### I. Overview

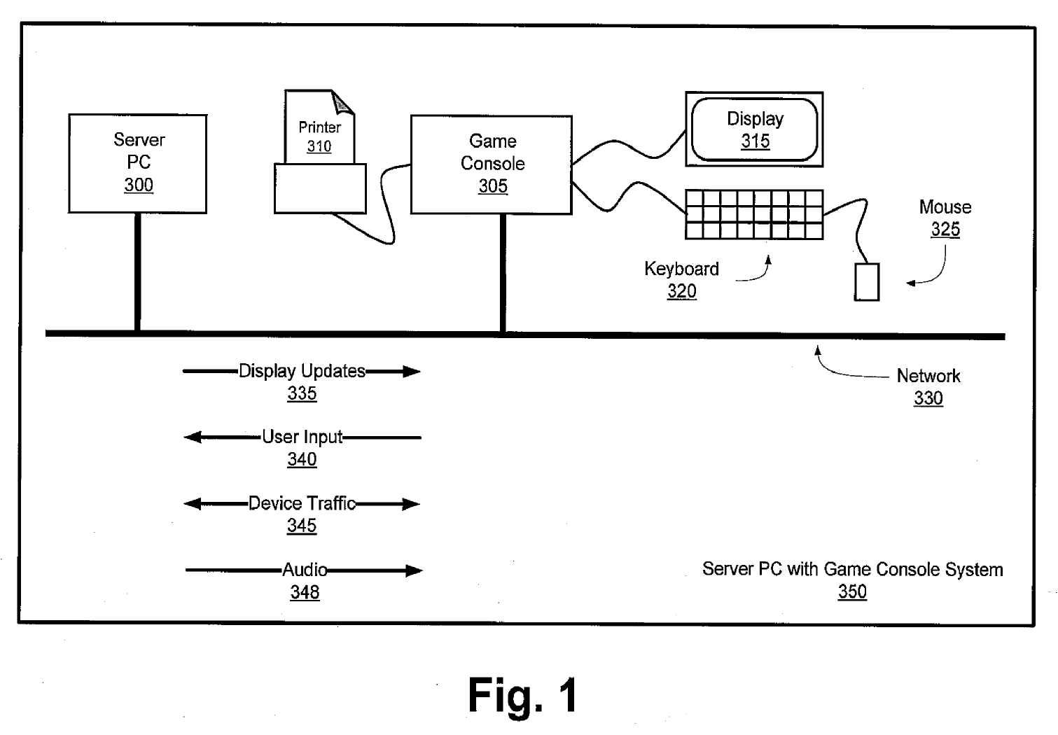

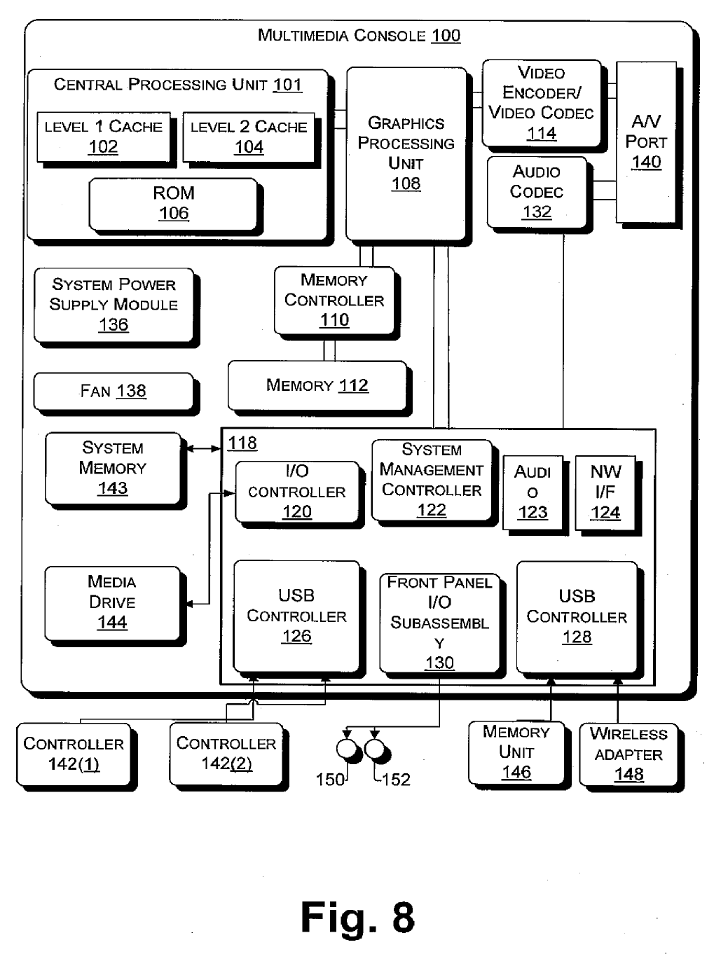

According to various aspects described herein, users can have PC experiences on game consoles without having to move to different locations and/or different machines. There are at least two ways in which this can be accomplished: (1) By having game consoles be dedicated computing devices to PCs, and, alternatively, (2) by having game consoles be concurrent computing devices with PCs. Various aspects of each of these exemplary and non-limiting scenarios is described in detail in FIGS. 1-7. Moreover, in FIGS. 8-10, various aspects of exemplary and non-limiting PCs, game consoles, and networked environments are provided.

### II. Aspects of Rich and Concurrent PC Experiences on Game Consoles

In various aspects described herein, users can have PC experiences on game consoles. However, it should be understood that “game consoles” are merely exemplary and non-limiting such computing devices, and other consumer electronics devices, such as personal digital assistant (PDA) devices, portable music devices, and so on, equally qualify to stand-in for the below discussed “game consoles.” Moreover, “game consoles,” as such entail any computing devices for playing games.

For example, FIG. 1 provides a general architecture of a PC along with a game console, showing how these devices may be connected to provide a rich and concurrent PC experience to users. The notion of a “PC experience” entails not only providing a visual experience to users of game consoles, but also (or alternatively) it entails the leveraging of a PC's computational power to a game console (as for example, when the PC executes applications locally and then remotes them to the game console). In cases where PC may be faster at performing some tasks, they may execute content locally and provide it locally. However, in cases where the game console may have better or more apposite resources, content can be executed on the game console.

A PC acting as a server 300 is shown, and this server 300 can be connected to some network 330 (as is described in more detail below, such network includes but is not limited to an Ethernet network, a wireless network, and so on). A game console 305 can also be connected to this network 330, and thus the game console 305 and the PC 300 can communicate with each other.

As is well understood in the art, the server PC 300 may have a plurality of peripheral devices (not shown), including printers, keyboards, mouses, and so on. However, additionally, FIG. 1 shows that such peripheral devices may also be connected to the game console 305. Thus, a printer 310 could be connected via a universal serial bus (USB) to the game console 305. Similarly, a display 315, a keyboard 320, and a mouse 325 can be connected to the game console 305. Devices native to the game console (shown in FIG. 8), such as game controllers, can also be used.

In this general PC and game console system 350, typical PC experiences, whether desktops and/or applications, can be consumed by users of game consoles. There are literally thousands of such experiences designed for PCs but amenable (in this aspect of the present disclosure) for running and/or displaying on game consoles. For example, media management applications can be used, where rich PC interfaces are provided for managing media content, playlists, file hierarchies, and entering data. Device management applications can be used to manage content in a portable media player, download or acquire content, clean up pictures in a camera, upload pictures to a HDD, and so on. Application remoting can be employed, such as when a game console is present in a room where no PCs are present. Information browsing applications can also be used, providing for browsing of information about games users are playing, music playback control, control of IP enabled Audio Video gear, web mail, news reading, and so on. Communication applications can be used for various flavors of instant messenger and their rich enhancements, VoIP, email, and so on. Casual game play can be engaged, with HTML/web games or simple desktop games, like solitaire, that can be played on the side while other main activity is going on in the console, such as watching TV through a media center extender, or watching a DVD. Media consumption applications can be used, including slide shows, music and video playback, shared reading or browsing. Household management applications can also be experienced on the game console, including calendars, access to a web cam or a household security system, caller ID, and so on. These are but a few of the exemplary PC experiences that can be remoted to or dedicated by game consoles.

Practically, this means that users could have one PC in a home storing a particular document and then use N number of devices and access that same document and edit it. In this exemplary and non-limiting scenario, such users would not have to make copies of the document on the various (N number of) devices. Instead, one copy could be stored on the PC and accessed from a plurality of devices (whether stationary devices or mobile devices).

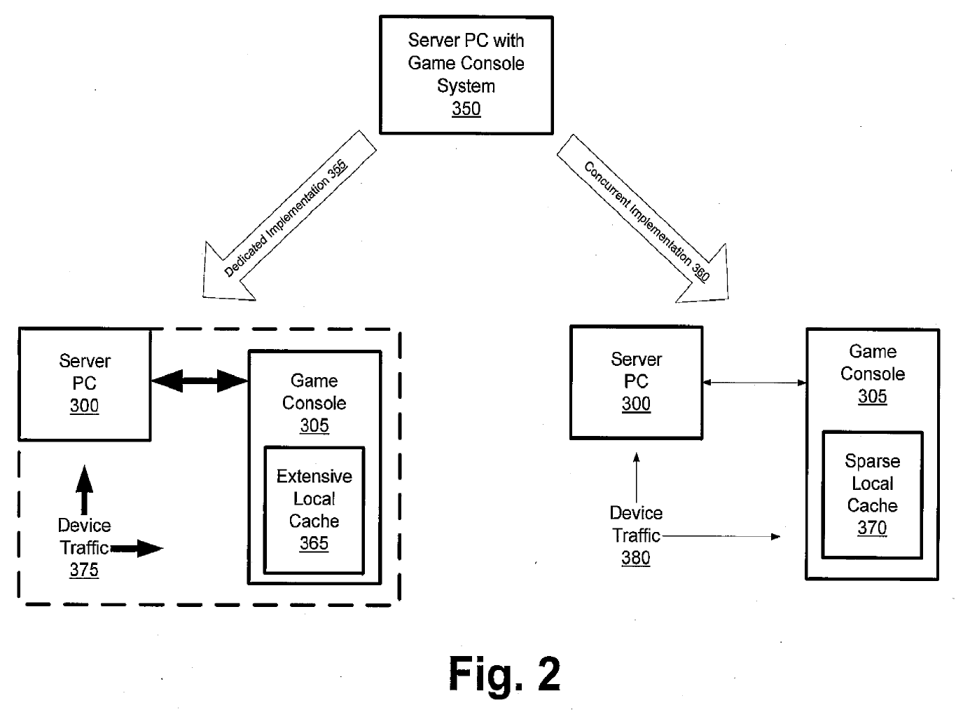

Next, FIG. 2 illustrates that the overall PC and game system 350 may be implemented in a variety of ways, including but not limited to (1) a dedicated system 355, where the game console 305 is dedicated to the PC 300, and (2) a concurrent system 360, where the PC 300 and the game console 305 interact as concurrent subsystems. In the former scenario, a full PC desktop, for instance, could be provided to the game console 305, with complete device sharing between the devices. Thus, all USB device ownership can be transferred over from the game console 305 to the PC 300 by remoting the USB traffic. In this set up, extensive local caching on the game console 305 can be used to allow for improved performance of the overall system 350.

In the latter scenario, the concurrent implementation 360 can be a lightweight experience that is concurrent with any primary game console 305 activity, whether that activity is playing a game, watching TV, watching a movie, or any other entertainment experience the game console might provide. This lightweight experience can be optimized for minimal intrusion on game console 305 resources, with almost no local caching, no device traffic, and minimal application remoting.

FIG. 2 shows that in the dedicated implementation 355, the game console 305 provides for extensive local cache 365, and thus it acts as an extension device of the server PC 300 (the dashed lines show the server PC 300 as encompassing the game console 305 because the game console 305 is dedicated to the PC 300). Thus, there is heavy device traffic 375 between the PC 300 and the game console 305. In practical terms, this means that, for instance, a printer can be connected to the game console 305 and it can be used by the server PC 300; alternatively, a DVD burner can be plugged into the PC 300 and it can show up as a device for use by the game console (to burn games, movies, music, and so on). The heavily weighted arrow between the server PC 300 and the game console 305 shows that applications are heavily remoted (and then cached 365) between the server PC 300 and the game console 305. In essence, in this dedicated implementation 365, the server PC 300 and the game console 305 logically behave as one computing device.

In contrast, in the concurrent implementation 360 scenario, the PC 300 and the game console 305 are separate but concurrent computing devices that communicate and share information and resources, but in a more limited way. Thus, the caching 370 is kept to a minimum, the device traffic (per the printer and DVD burner example above) is minimal (or perhaps non-existent, depending on the specific design details), and applications remoted are limited. Thus, in this scenario 360, the server PC 300 provides some PC experiences to the game console 300, but these experiences are more limited than in the dedicated implementation 365. And yet, this scenario 360 allows for more computing device 300, 305 independence, and less reliance on network communication between such computing devices 300, 305.

The server PC with game console system 350 has numerous aspects when used with either of the two implementations 360, 365. For example, on a broad level, the system 350 can: extend PC applications to game consoles; remote PC applications to game consoles; remote PC desktops to game consoles; remote device traffic from game consoles to PCs; display PC experiences over game console activity (either via overlaying or switching); signal significant events when the PC experience is hidden; provide 100% compatible PC and game console applications; and provide concurrent experience with the game console's primary activity. Of these enumerated aspects, it is apparent that the first aspect belongs to the dedicated implementation 365, and that the last aspect belongs to the concurrent implementation 360. Those of skill in the art will readily appreciate that these two implementations 360, 365 on some level of abstraction may overlap, and the aspects discussed herein, in between the first and the last enumerated aspect, may be implemented in either or both of the implementations 360, 365 (or even some hybrid implementation).

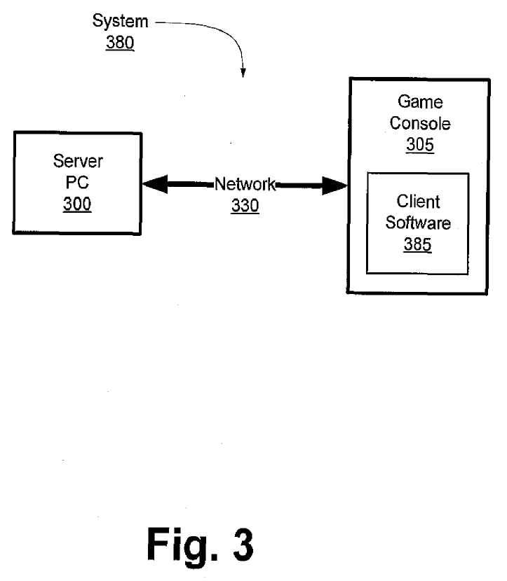

FIG. 3 illustrates an aspect of the present disclosure that has client software running on the game console, where this software facilitates a PC-like experience on the game console. This system 380 extends game console functionality to encompass a very rich PC experience. This can be done as part of the client software 385 running on the game console 305 that can communicate both ways with a server PC 300 located elsewhere (e.g. in a household) through any networking method, and then present that experience to the console user as an overlay or replacement to whatever primary activity the game console is engaged in. As mentioned above, the server PC 300 can present specific applications or an entire PC desktop to the game console 305 through a protocol that exchanges display updates, user input, local device traffic, and audio. This protocol can be similar to the Remote Desktop Protocol (RDP), which as those of skill in the art will appreciate, is a multi-channel protocol that allows users to connect between computing devices. It may include various features, such as: 24-bit color support, giving a palette of 16.7 million colors or more; 128-bit encryption, using a RC4 encryption algorithm (this may be the default security; older clients may use encryption of lesser strength); transport layer security support; audio support that allows users to run an audio program on the remote desktop and have the sound redirected to the game console; file system redirection that may allow users to use their local PC files on a remote game console; printer redirection that may allow users to use their local PC printer while navigating the game console; port redirection that may allow applications running within a PC session to access directly local serial and parallel ports on the game console; and sharing the resources of local PC hard drives in remote game consoles (which may be especially useful if users are using their game consoles as, say, DVR media centers, and may want to store content on their PCs—and not on their game consoles—so as to provide maximum resources for gaming activity on the game console).

The system 380 shown in FIG. 3 may use a PC that already exists in the household, and simply connect it to a game console 300 via a network 330. As was mentioned above, PC-like input devices (keyboards and/or mouses) may be connected to the game console, and a PC-quality display device (such as HDTV or computer monitor) can comfortably display the higher density UI typical of most PC applications. Furthermore, all applications can execute on the server PC 300, and their appearance can be displayed on the game console if a particular application is active. All user input can come from the game console input devices and it can be converted to the network protocol (RDP). Devices, such as printers, can have their raw device bus traffic (such as USB) carried over the network protocol, such that to the server PC 300 it appears that those devices were plugged in locally, enabling scenarios such as managing pictures in a digital camera or printing documents on the game console.

Thus, turning back to FIG. 1 temporarily (FIG. 3 being an abstraction of sorts of FIG. 1), it is shown that display updates 335 can be provided from the server 300 to the game console 305. Conversely, user input 340 can be provided from the game console 305 to the server PC 300. Device traffic 345, discussed in detail above, can communicated both ways between the server PC 300 and the game console 305. And, as mentioned, audio signals can be provided from the server PC 300 to the game console 305 (e.g. gamers can play songs stored in their PC media libraries while playing games on the game console). Of course, those of skill in the art will readily appreciate that the direction of the various signals 335, 340, 345, 348 can occur in other directions (or in both directions) than what is disclosed herein. This much is merely an implementation detail, contemplated by the breadth and scope of the present disclosure.

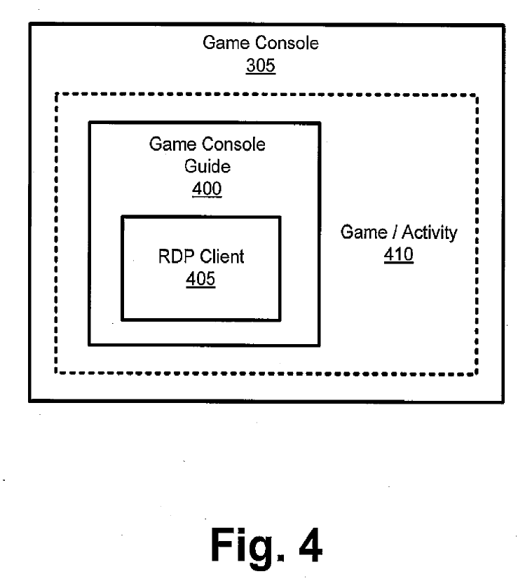

Next, FIG. 4 illustrates another aspect of the present disclosure, wherein a game console has a game console guide 400 with an RDP client 405. The guide 400 and the client 405 can be overlayed on any game or activity 410 by pressing a specific button on some input device, such as a controller. It is understood that a game controller can be any input device used to control the game console and any software running thereon, such as video games. A game controller can be a keyboard, mouse, gamepad, joystick, paddle, remote control or any other device designed for gaming that can receive user input. This also includes special purpose devices, such as steering wheels for driving games and light guns for shooting games, and so on.

In one aspect of the present disclosure, the client 405 uses almost no game console 305 local memory when not brought up by the user. It does this by not storing any state locally, other than connection data, so it can reconnect to any appropriate server PCs. When a user does bring up the client 405, the client 405 can appear on the game console 305 screen and at that point local game console 305 memory, including display memory, can be used for storage of the appearance of PC applications and/or desktops. Moreover, the client 405 can request full game console 305 screen updates from the corresponding server PC, so no history of updates is needed, and then take over any input devices at that point. The amount of memory caching, device traffic, and so on, will depend on the type of implementation 360, 365 employed.

As mentioned, input can be provided through gamepads, mouses, keyboards (in short, any controllers), whether wired or wireless, or any USB-like device connected to the game console 305. At any point, users can set aside the PC experience to go back and forth to a primary game console activity, with fairly short transition times. As was mentioned, the game console may remotely present a single specific purpose application or an entire desktop. Typically, for the concurrent use implementation 360 with a primary game console 305 activity, remoting a single application will be more prevalent from a use point of view, but in a PC replacement scenario, such as the dedicated implementation 365, the entire desktop PC may be remoted. In any case, users can create new sessions for each new application they would like to run (e.g. new instances of a browser, or a different application altogether, such as instant messenger client or an email client). It should be also noted that remoting a single application may be desirable for many reasons, including ease of use, fitting application in limited screen resolution, and software licensing limitations.

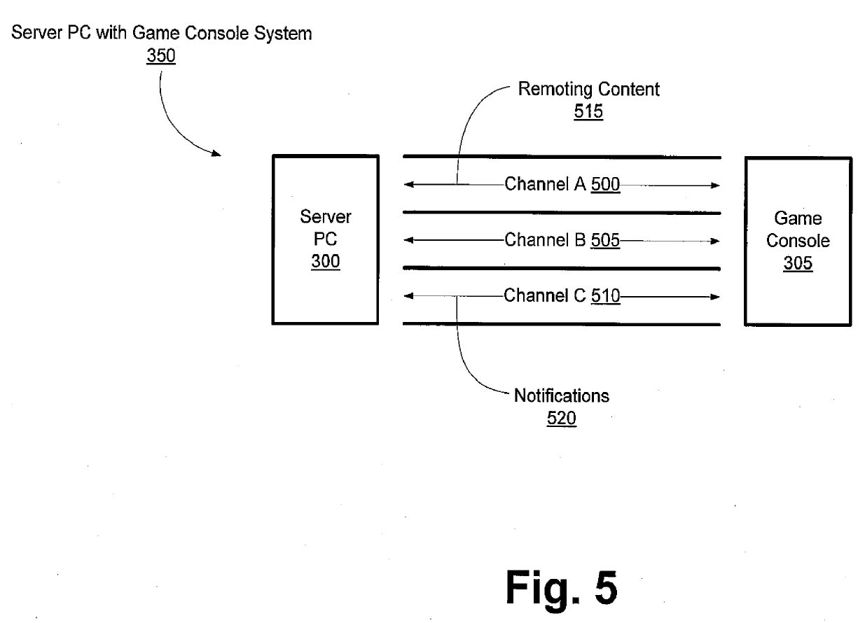

In another aspect of the present disclosure, FIG. 5 illustrates that the server PC and game console system 350 can use separate communication channels for different activities. Specifically, per FIG. 5, channel A 500 can be used for the PC-experience activities discussed so far, namely, display updating, input remoting, device trafficking, and so on, while channel C 510, for example, can be used for signaling of important messages for calling attention to events on any given (or each) application—similar to a modal dialog coming up, or other events such as application existence, new message received, and so on. This feature can be used when applications are not active (i.e. not visible in the foreground) for users on the game console 305. There can be a plurality of such channels 500, 505, 510, and such channels may be communicated in a variety of ways, such as by multiplexing or other communications means.

Aside from the various systems discussed so far, the present disclosure may be implemented in various methods and computer readable media. Although, it should be noted that aspects disclosed so far as systems (FIGS. 1-5) can just as easily be practiced as methods and computer readable media (and vice versa) when read in the context of the present disclosure. Thus, the foregoing and following discussion applies similarly to systems, methods, computer readable media, apparatuses, etc.

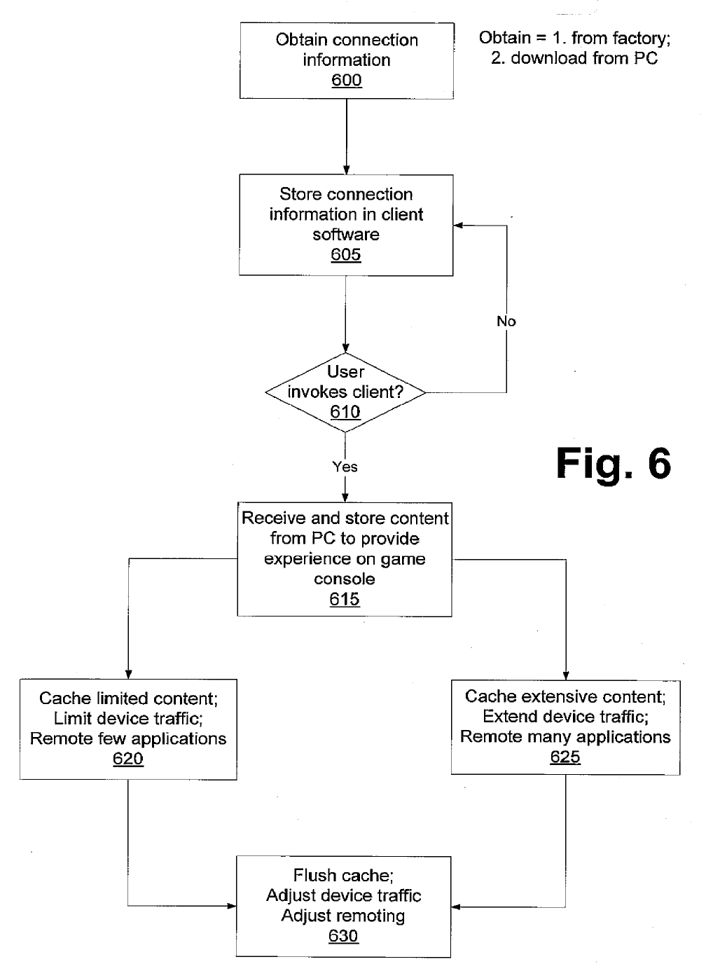

Thus, FIG. 6 illustrates in a block diagram flow chart one aspect of how users can have PC experiences on game consoles. At block 600, information (e.g. code and/or data) is obtained as to how a client software program residing on a game console should connect up to a server PC. Such information may initially be embedded in the client software program, or it may be downloaded from different sources. In any event, once such information is obtained, at block 605, it is stored in the client software. As was mentioned, this client software is one of the components that enables users to have a PC experience on the game console.

When the client software is installed on a game console, it can monitor when and if users invoke the client. For example, users may want to use an email application when playing some video game on the game console. The client software would initialize communications with a server PC with such an email application, and then the server PC would remote this application to the game console. One way in which this could be accomplished is via the RDP (discussed in detail above—however, other similar and alternative protocols could be used, as those of skill in the art will readily appreciate).

In any event, once the user invokes the client, at block 610, the client component can start to receive and store any content (e.g. applications, files, or even the entire desktop) on the game console. Just how much of this content will be cached depends on the extent to which the client software is configuring the game console to be a dedicated computing device, or on the other hand, a concurrent computing device with the game console. In one aspect, minimum amount of resources can be served on the game console for such caching, such as 5%. For optimal gaming performance, the latter implementation will be favorable, since primary software (namely, games) running on the game console will receive access to most of the resources. Conversely, for a richer PC experience, the dedicated implementation (with more extensive caching, device sharing, and remoting) will be probably used. This choice between the two implementations is illustrated at blocks 620 and 625, respectively.

Finally, after the user have accessed the initially invoked (at block 610) content, such content can be flushed from the cache (or it may be archived, if it is anticipated according to some heuristic that it may be needed again). Additionally, the device trafficking relationship between the game console and the server PC can be dynamic in that it can change over time, either due to user actions, user settings, and/or other events. Similarly, the extent of remoting, e.g. only remoting an application or two, versus remoting an entire desktop, can also be adjusted in a similar fashion—that is, due to user actions, user settings, and/or other events.

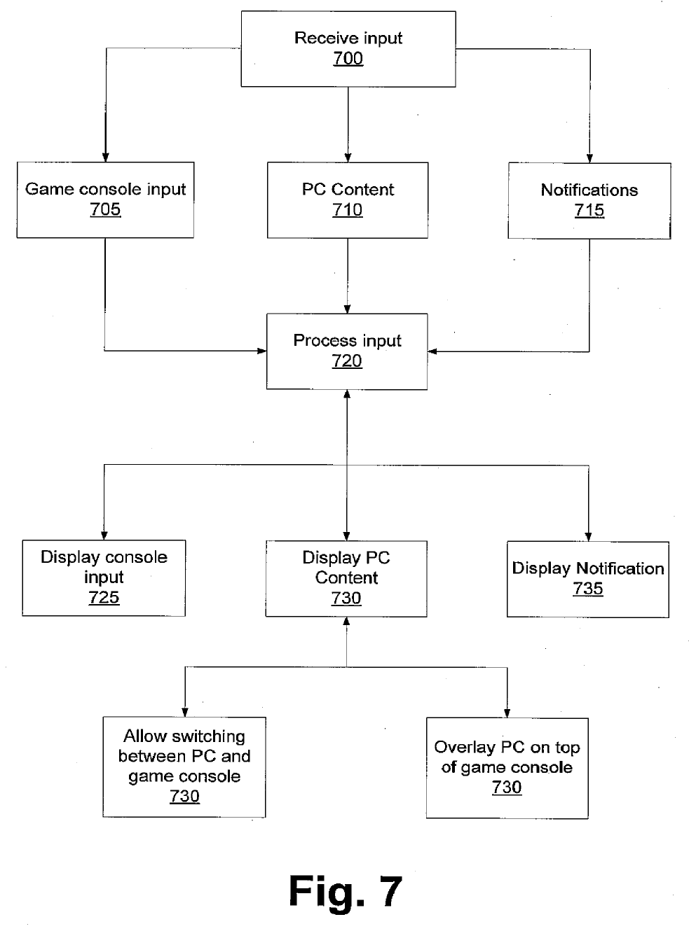

Next, FIG. 7 illustrates in a block diagram flow chart another aspect of how users can have PC experiences on game consoles. At block 700, the game console can receive input (or, more specifically, the software client residing on the game console). The input can be of various types: game console input, block 705, PC content, block 710, and notifications sent from a server PC to the game console, block 715. The first input, block 705, can come from controllers, DVDs input into the game console (e.g. games), and so on. The second input, at block 710, can come from the server PC and it can include applications and/or the entire PC desktop. Lastly, the third input, block 715, can provide notifications to the game console. Such notifications, as mentioned above, can signal important messages, calling users' attention to events on any one application and/or desktop. Whatever the input, this input is eventually processed 720. Processing, as those of skill in the art will readily appreciate, can entail caching data that's being input, using devices shared between the game console and the PC, and so on.

In any event, once input is processed at block 720, it may be used for other purposes. By way of example only and not limitation, processed input can be displayed (of course, it may be manipulated in other ways also). In the case of the first input, at block 705, this input can be displayed as a graphics rendered game (block 725); the second input, at block 710, can be played as an application or desktop (while the actual application is being executed in the server PC but displayed on the game console—alternatively, in some embodiments, it may be executed on the game console, if such a game console has enough native resources); and the third input, can display notifications in a variety of ways (windows, pop-ups, and via other audio/video applications).

Again, by way of example only and not limitation, the displayed PC content, at block 730, can be shown in a variety of ways, whether it is overlayed on the game console display (essentially amounting to reducing the game console to a dedicated role vis-à-vis the PC) or whether it is configured to switch between the PC experience and the native game experience. This much is an implementation detail, not limiting any aspects of the presently disclosed subject matter.

### III. Exemplary Game Console, PC, and Networking Aspects

So far, it has been disclosed that (1) game consoles can be used to provide (2) PC experiences via (3) a network. Each of these three components is discussed in more detail herein. First, this section of the present disclosure provides the general aspects of an exemplary and non-limiting game console. Referring now to FIG. 8, a block diagram shows an exemplary multimedia console. The multimedia console 100 has a central processing unit (CPU) 101 having a level 1 (L1) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a flash memory device (not shown). Furthermore, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity, 3D, surround, and stereo audio processing according to aspects of the present invention described above. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community. In this latter scenario, the console 100 may be connected via the network 330 of FIG. 1 to the server PC 300.

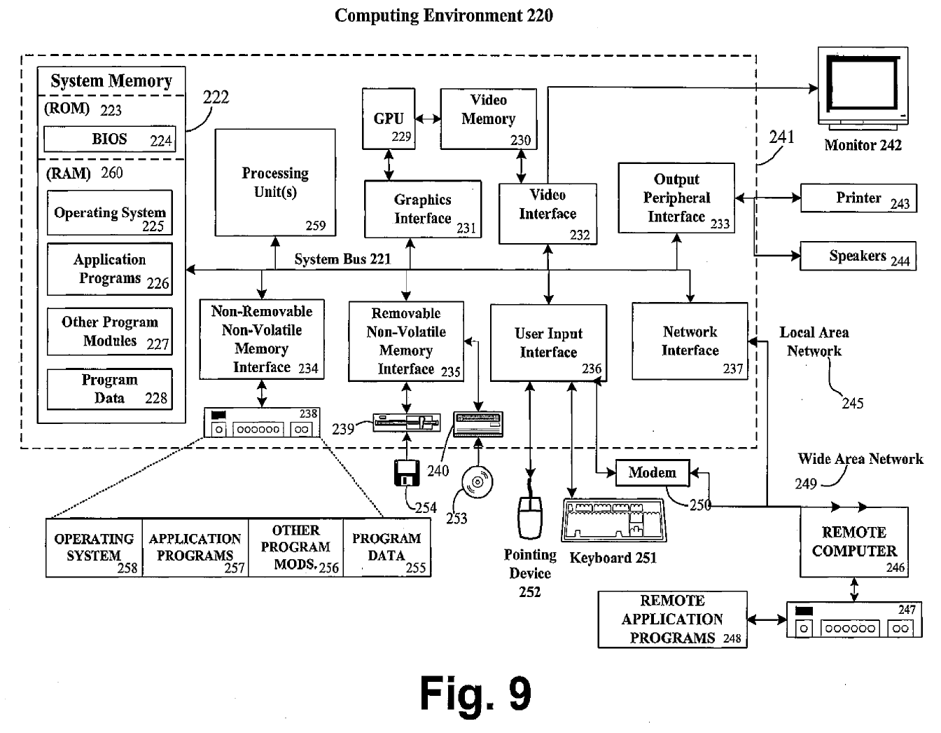

Second, now turning to FIG. 9, it shows a block diagram representing an exemplary computing device suitable for use in conjunction with implementing the subject matter disclosed above. For example, the computer executable instructions that carry out the processes and methods for providing PC experiences on gaming consoles may reside and/or be executed in such a computing environment as shown in FIG. 9. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220.

Computer 241 typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 9 illustrates operating system 225, application programs 226, other program modules 227, and program data 228.

The computer 241 may also include other removable/non-removable, volatile/nonvolatile computer storage media. By way of example only, FIG. 9 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 9, provide storage of computer readable instructions, data structures, program modules and other data for the computer 241. In FIG. 9, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 9. The logical connections depicted in FIG. 9 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 9 illustrates remote application programs 248 as residing on memory device 247. It will be appreciated that the network connections shown are exemplary and other means of establishing a communications link between the computers may be used.

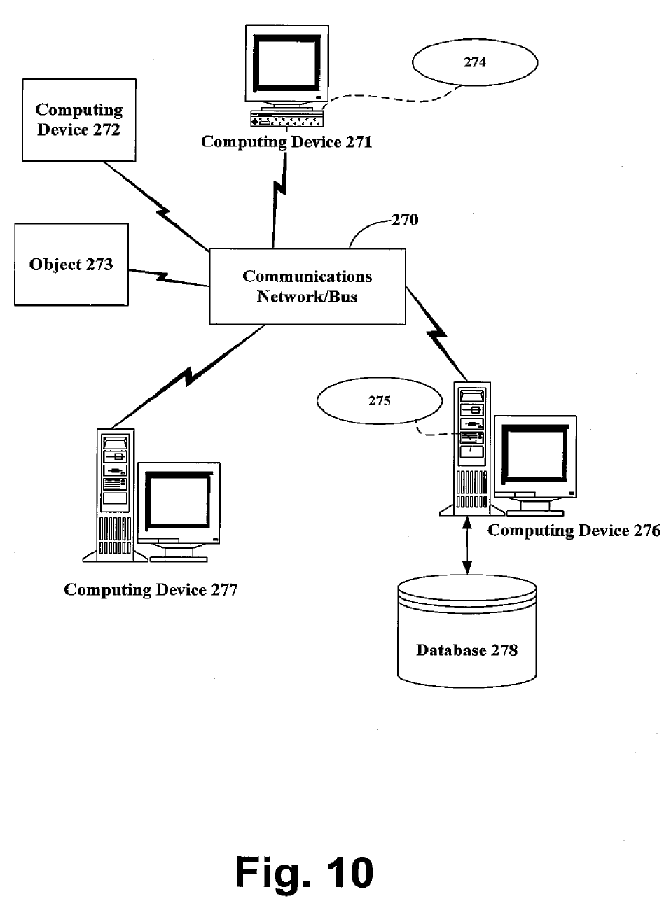

Third, and last, FIG. 10 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, smart phones, DVD players, cable box tuners, or just about any computing devices capable of remoting content provided by server PCs. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 10, and may itself represent multiple interconnected networks. In accordance with an aspect of the presently disclosed subject matter, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 10, any entity 271, 272, 273, 274, 275, 276, 277 and 278 can be considered a client, a server, or both, depending on the circumstances. And, moreover, regarding the game console, it can be a client to the server PC shown in FIGS. 1-5.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 10 and the further diversification that can occur in computing in a network environment such as that of FIG. 10, the systems and methods provided herein cannot be construed as limited in any way to a particular computing architecture or operating system. Instead, the presently disclosed subject matter should not be limited to any single embodiment, but rather should be construed in breadth and scope in accordance with the appended claims. Thus, for example, although game consoles and server PCs have been discussed, just as easily full desktops could be remoted to smart phones as a means to access data and functionality that is otherwise unavailable to smart phones.

Finally, it should also be noted that the various techniques described herein may be implemented in connection with hardware or software or, where appropriate, with a combination of both. Thus, the methods, computer readable media, and systems of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Lastly, while the present disclosure has been described in connection with the preferred aspects, as illustrated in the various figures, it is understood that other similar aspects may be used or modifications and additions may be made to the described aspects for performing the same function of the present disclosure without deviating there from. For example, in various aspects of the disclosure, the providing of PC experience on game consoles was disclosed. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for providing users personal computer (PC) experiences on game consoles, comprising:
a server PC configured to provide content over a network;
a game console communicatively coupled to said server via said network; and
a software client residing on said game console, wherein said client allows users to experience PC content on said game console that is executed on said server, wherein said client receives remoted content from said server, caches said content, and traffics any devices between said server and said game console that apply to said content.

2. The system according to claim 1, wherein said content includes at least one (a) of an application residing on the PC and (b) a desktop of the PC.

3. The system according to claim 1, wherein said communicative coupling between said server and said game console uses at least two channels, wherein a first channel is used for said content, and wherein a second channel is used for notifications.

4. The system according to claim 3, wherein said notifications are related to said content.

5. The system according to claim 1, wherein said communicative coupling includes the sending at least one of (a) display updates, (b) user input, (c) device traffic, and (d) audio signals.

6. The system according to claim 1, wherein said content is one of (a) overlayed on a game console display and (b) configured to be switched between itself and said game console display.

7. The system according to claim 1, wherein said content is cached in reserved resources of said game console.

8. A method for providing users personal computer (PC) experiences on game consoles, comprising:
receiving content over a network sent from a server PC to a game console; and
using a software client residing on said game console, wherein said client allows users to experience PC content on said game console that is executed on said server, wherein said client receives remoted content from said server, caches said content, and traffics any devices between said server and said game console that apply to said content.

9. The method according to claim 8, further comprising including at least one (a) of an application residing on the PC and (b) a desktop of the PC as said content.

10. The method according to claim 8, further comprising communicatively coupling said server and said game console using at least two channels, wherein a first channel is used for said content, and wherein a second channel is used for notifications.

11. The method according to claim 10, further comprising relating said notifications to said content.

12. The method according to claim 10, further comprising sending at least one of (a) display updates, (b) user input, (c) device traffic, and (d) audio signals via said coupling.

13. The method according to claim 8, further comprising processing said content as one of (a) an overlay on a game console display and (b) a switchable content between itself and said game console display.

14. The method according to claim 8, further comprising caching said content in reserved resources of said game console.

15. A computer readable medium bearing computer executable instructions for providing users personal computer (PC) experiences on game consoles, comprising:
a first instruction for receiving content over a network sent from a server PC to a game console; and
a second instruction for using a software client residing on said game console, wherein said client allows users to experience PC content on said game console that is executed on said server, wherein said client receives remoted content from said server, caches said content, and traffics any devices between said server and said game console that apply to said content.

16. The computer readable medium according to claim 15, further comprising a third instruction for including at least one (a) of an application residing on the PC and (b) a desktop of the PC as said content.

17. The computer readable medium according to claim 15, further comprising a third instruction for communicatively coupling said server and said game console using at least two channels, wherein a first channel is used for said content, and wherein a second channel is used for notifications.

18. The computer readable medium according to claim 17, further comprising a fourth instruction for relating said notifications to said content.

19. The computer readable medium according to claim 17, further comprising a fourth instruction for sending at least one of (a) display updates, (b) user input, (c) device traffic, and (d) audio signals via said coupling.

20. The computer readable medium according to claim 15, further comprising a third instruction for processing said content as one of (a) an overlay on a game console display and (b) a switchable content between itself and said game console display.
